(19) United States
(12) Patent Application Publication
(10) Pub. No.: US 2016/0333901 A1
(43) Pub. Date: Nov. 17, 2016

(54) FAIL FIXED ACTUATOR

(71) Applicant: Triumph Engine Control Systems, LLC, West Hartford, CT (US)

(72) Inventor: William Dalton, Amston, CT (US)

(21) Appl. No.: 14/712,989

(22) Filed: May 15, 2015

(51) Int. Cl. F15B 15/22; F15B 11/08

(52) U.S. Cl. CPC F15B 15/222; F15B 11/08; F15B 2211/8752; F15B 2211/40515

(57) ABSTRACT

A fail fixed actuator utilizing a rotary cam and servo are provided herein.

### FIELD OF THE INVENTION

The present invention relates generally to hydraulic actuators and more particularly, but not exclusively, to a fail fixed hydraulic actuator that utilizes a rotary cam and servo mechanism for fixing the position of the actuator upon system failure.

### BACKGROUND OF THE INVENTION

Hydraulically operated, linear acting actuators are used commonly amongst a variety of industries. Actuators utilize hydraulic power to move devices against some applied force. The position of the actuator is usually a function of an electronic device, most commonly a torque motor. The torque motor takes an electronic signal and manipulates the hydraulic power to position the actuator against a mechanical load.

In many actuator systems, when the electrical signal is lost, the actuator either moves to the zero signal position, or drifts against the load. For a variety of aerospace applications, it is desirable to have the actuator remain in the last commanded position in the event of an electrical signal failure. Such devices are known as “fail fixed” actuators.

Certain fail fixed actuators are known in the field. For example, many fail fixed actuators work on the principle of creating a hydraulic lock, which can leak over time. By leaking, the actuator may drift away from its failed position. Alternatively, some fail fixed actuators require a complicated array of controlling devices, in addition the normal control mechanisms, such as friction bearing mechanisms to hold the actuator in place.

Accordingly, there is a need in the field for fail fixed actuators that may fix the position of the actuator upon failure with minimal or zero drift without the aid of additional friction devices.

### SUMMARY OF THE INVENTION

The actuators of the invention meet the needs in the field and include a fail fixed actuator that provides a linear acting actuator. The invention may utilize a rotary cam (e.g., a cam cylinder) in conjunction with a follow on servo to create a fail fixed actuation system that meets the needs in the field. According to certain aspects, the invention includes a fail fixed linear actuator for an aircraft.

The present invention encompasses a fail fixed actuator that may include a rod having a piston and a fluid channel extending axially through the rod. The rod may have a servo orifice at a surface of the rod that may be in fluid communication with the fluid channel. The actuator may include a cam cylinder that may cover a portion of the rod in close fitting relation. Moreover, the cam cylinder may include a groove or cut out from the cam. In preferred embodiments, the cam is a cam cylinder that may surround a portion of the rod in close fitting relation. The servo orifice and a portion of the groove or cut out may combine to form an aperture that may be dilated or contracted depending upon the position of the cam with respect to the rod and the servo orifice provided thereon.

The actuator may include a motor connected to the cam cylinder. The motor may be provided to rotate the cam cylinder about the rod, as required, to adjust or vary the size of the aperture.

The actuator may also include a piston chamber that may be configured to contain the piston of the rod. The piston chamber may include a high pressure chamber or zone and a servo pressure chamber or zone. For example, one face of the piston may be exposed to the high pressure chamber and the other face of the piston may be exposed to the servo pressure chamber. The servo pressure chamber may be in fluid communication with the fluid channel.

In addition, the actuator may include a low pressure chamber that may be provided to fluidly communicate with the aperture and, therefore, the servo orifice. Movement of at least one of the cam and rod may vary the size of the aperture and thereby adjust fluid flow therethrough.

More broadly, the present invention utilizes a servo control device to position the actuator, which does not rely on an applied electrical signal to hold the actuator in position. The electrical signal may be used to move the actuator and then may no longer be required, as hydraulic pressure may remain along with normal friction to hold the actuator in place. Thus, creating a fail fixed actuator, with zero drift, and without the aid of additional friction devices applied to the actuator. In specific embodiments of the invention, the actuator may utilize a stepper motor to position a gear driven cam that may ultimately position the actuator. Once the cam reaches the commanded position, the electrical signal may be terminated, and hydraulic power moves the actuator to the desired position.

The foregoing invention, which is described in greater detail below, provides needed advancements in the field of fail fixed actuators.

### BRIEF DESCRIPTION OF THE DRAWINGS

The foregoing summary and the following detailed description of the exemplary embodiments of the present invention may be further understood when read in conjunction with the appended drawings, in which:

FIG. 1 schematically illustrates a fail fixed actuator of the invention.

FIGS. 2A and 2B schematically illustrate top (FIG. 2A) and side (FIG. 2B) perspective views of the cam cylinder in relation to the rod of the fail fixed actuator of the invention.

### DETAILED DESCRIPTION OF THE INVENTION

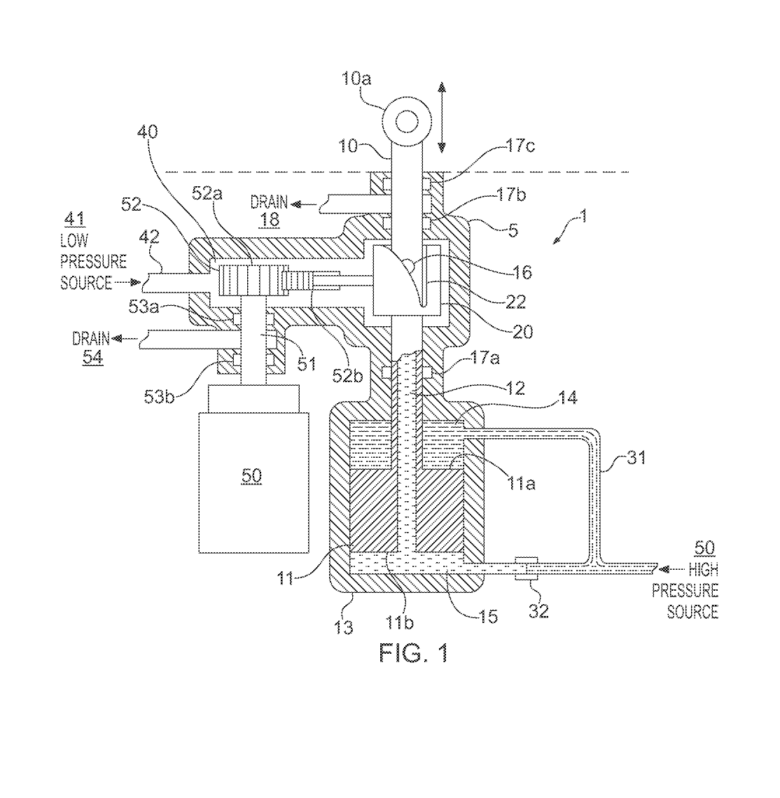

Referring now to the figures, wherein like elements are numbered alike throughout, FIG. 1 exemplifies a fail fixed actuator 1 of the invention that includes a housing 5, through which a rod 10 passes to operate another device or mechanism that is affixed or otherwise connected to the rod end 10A.

The rod 10 may include a piston 11 and the rod 10 may have a hollow shaft disposed within it, such as fluid channel 12. The fluid channel 12 may extend axially through the rod 10 from the piston 11. The rod 10 may include a servo orifice 16 at a surface of the rod 10 that may be in fluid communication with the fluid channel 12. The fluid channel 12 may terminate at a point before the rod end 10A. However, in preferred aspects of the invention, the fluid channel 12 will extend at least until it reaches the servo orifice 16.

The piston 11, which may be placed at one end of the rod 10, may be disposed within a piston chamber 13. As shown in FIG. 1, the piston 11 may bisect the piston chamber 13 into two chambers on either face of the piston 11.

Chamber 14, the high pressure chamber, may be in fluid communication with a source of high pressure fluid 30, which may be a high pressure hydraulic reservoir that may further include a hydraulic pump, as is known in the art. Accordingly, the high pressure source 30 may provide high pressure fluid to the high pressure chamber 14 via line 31.

Chamber 15, the servo pressure chamber, may be in fluid communication with the high pressure source 30. The high pressure source 30 may provide pressurized fluid to the servo pressure chamber via line 31, which communicates with the servo pressure chamber through a flow restrictor 32. The flow restrictor 32, or feed orifice, may be a pinhole orifice.

Accordingly, the piston 11 may have a high pressure face 11A and a servo pressure face 11B. The high pressure fluid may be said to act on the high pressure face 11A and the fluid within the servo pressure chamber may be said to act on the servo pressure face 11B.

The actuator 1 may include a low pressure fluid chamber 40 that may be in fluid communication with a source of low pressure fluid 41, which may be a low pressure hydraulic reservoir that may further include a hydraulic pump, as is known in the art. Accordingly, the low pressure source 41 may provide low pressure fluid to the low pressure chamber 40 via line 42. As used herein, the terms low pressure fluid and high pressure fluid describe the relative pressures of the hydraulic fluids disposed within the low pressure chamber 40 and high pressure chamber 14, respectively. Therefore, the measured fluid pressures in each of the low pressure and high pressure chambers may be selected by a person having ordinary skill in the art, provided that the fluid pressure in the low pressure chamber is less than the fluid pressure in the high pressure chamber.

Furthermore, the rod 10 may also be placed in contact with one or more seals 17 (e.g., O-ring seals) disposed around the rod 10 within the housing 5. For example, the rod 10 may contact a rod seal 17a, placed within the housing 5, such that the rod seal 17a may sealingly engage with a surface of the rod 10 between the piston 11 and the servo orifice 16. The rod seal 17a may prevent fluid leakage between the piston chamber 13 and the low pressure chamber 40, or vice versa. The rod 10 may contact rod seals 17b and/or 17c. Such rod seals 17b and/or 17c may prevent the leakage of fluid from the low pressure chamber 40, for example. The rod 10 may also include a drain 18 disposed within the housing 5 that may collect excess fluid from, for example, the low pressure chamber 40 that may leak through the seal 17b. Fluid collected at the drain 18, may be transferred to a reservoir or removed from the actuator 1.

The servo orifice 16 may be in fluid communication with the low pressure fluid chamber 40. In specific aspects, the low pressure fluid chamber 40 may be in fluid communication with the servo pressure chamber 15 via the servo orifice 16 and the fluid channel 12.

The actuator 1 may include cam 20 that may cover a portion of the rod 10. Preferably, the cam 20 is a cam cylinder that may appear to operate in conjunction with the rod 10 as a valve. For example, the cam cylinder 20 may surround the rod 10 along a length of the rod 10 in close fitting relation while allowing the rod to move axially through the cylinder during operation. In preferred aspects, the cam cylinder 20 may be disposed about the rod 10 such that a portion of the cam cylinder 20 may obstruct the servo orifice 16. The cam cylinder 20 may include a groove 22 that, in certain aspects, may have a substantially triangular shape or V-shape. For example, the groove 22 may include an angled line having a fixed slope (e.g., the groove 22 may be in the shape of a right, obtuse, equilateral, or acute triangle). Alternatively, the groove 22 may include a line having a variable slope. Indeed, a line of the groove may be described as an exponential line, a logarithmic line, or the like. In certain other aspects, the groove 22 may be a cut out from the cam cylinder 20. The cam cylinder 20 may have at least one groove 22. In certain aspects, the cam cylinder 20 may have 1 to 4 grooves 22. Where the cam cylinder 20 includes one or more grooves 22, the rod includes an equal number of servo orifices 16. For example, where the cam cylinder 20 includes two grooves 22, the rod 10 will include two servo orifices 16.

The groove 22 of the cam cylinder 20 may be disposed at the rod 10 such that groove 22 may interact with, and obstruct, the servo orifice 16 as the rod 10 moves axially. Preferably, a portion of the groove 22 may occlude the servo orifice 16 and thereby form an aperture at the servo orifice 16 whose cross-section may be varied based upon the position of the cam cylinder 20 and the rod 10.

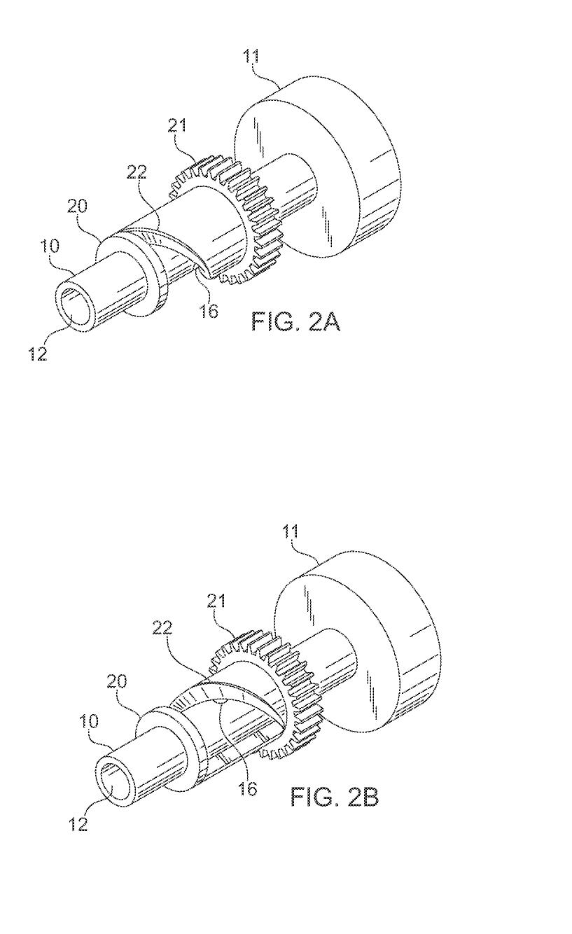

The cam cylinder 20 may be rotated about the rod 10 to adjust the interaction between the groove 22 and the servo orifice 16. As described herein, rotation of the cam cylinder 20 may be used to extend or retract the rod 10 by adjusting the interaction between the servo orifice 16 and the cam cylinder 20. With reference to FIGS. 2A and 2B, the cam cylinder 20 may include a cam gear 21.

The actuator 1 may include a motor 50 (e.g., an electric motor) in mechanical communication with the cam cylinder 20. Specifically, the motor 50 may be activated to rotate that cam cylinder 20 about the rod 10. For example, the motor 50 may be connected to the cam cylinder 20 via shaft 51 and gear train 52. The gear train 52 may interact with the cam gear 21 at the cam cylinder 20 to rotate the cam cylinder 20. The gear train 52 may include one or more gears, as would be understood by a person having ordinary skill in the art, such as gears 52A and 52B, as shown in FIG. 1. In certain preferred aspects, the motor 50 is a stepper motor. The motor 50 may also be in electrical communication with a controller and/or source of electric power for operating the motor 50.

Furthermore, the shaft 51 may also be placed in contact with one or more seals 53 (e.g., O-ring seals) disposed around the shaft 51 within the housing 5. For example, the shaft 51 may contact shaft seals 53a and/or 53b, placed within the housing 5, such that the shaft seals 53a and/or 53b may sealingly engage with a surface of the shaft 51 between the electric motor 50 and the gear train 52. The shaft seals 53a and 53b may prevent fluid leakage from the low pressure chamber 52. The shaft 51 may also include a drain 54 disposed within the housing 5 that may collect excess fluid from, for example, the low pressure chamber 40 that leaks through the seal 53a. Fluid collected at the drain 54, may be transferred to a reservoir or removed from the actuator 1.

Referring to the operation of the actuator 1, the actuator includes a linear acting rod 10 and piston 11, which is combined with a cam actuated follow up servo. High pressure may be fed into the feed orifice 32 (i.e., flow restrictor), which may be a fixed area orifice, such as a pinhole orifice. The orifice 32 reduces pressure which acts on the servo pressure side or piston head side 11B of the piston 11. A second orifice (i.e., the servo orifice 16) in series with the feed orifice 32 varies as a function of cam cylinder position. Orifice 16 further reduces pressure to the low pressure level within the low pressure chamber 40, which is the reference pressure to the system.

In the steady state position, the pressure ratios determined by the two orifices (i.e., orifices 16 and 32) work in conjunction with the area ratios of the piston 11, in order to maintain the piston 11, and therefore the rod 10, in a balanced position. High pressure works on the high pressure side or rod side 11A of the piston 11, which may be about half the area of the servo pressure side or piston head side 11B area, while servo pressure (which may be about half that of high pressure) works on the full piston head area; thus balancing the load.

The motor 50 may be provided to enact radial motion that, along with a gear train drive 52, rotates the cam 20 to adjust the size of the aperture at the servo orifice 16. In other words, the cam 20 may be rotated such that the groove 22 adjusts the exposed area of the servo orifice 16, which acts as a variable orifice.

As the aperture enlarges, the servo pressure reduces, thus causing the actuator rod 10 to move into the retracted position. When the orifice 16 catches up to the cam position as the rod 10 retracts, the aperture contracts (i.e., the exposed area of the servo orifice 16 decreases) and the servo pressure builds until the actuator comes to rest in a steady state position.

Similarly, the cam 20 rotates to reduce the exposed area of the servo orifice 16 (i.e., the aperture contracts), the servo pressure increases to extend the piston 11 and thereby the rod 10B until the servo orifice 16 catches up to the cam 20 or, more particularly, the groove 22 on the cam 20. When the servo orifice 16 catches up to the cam 20 due to extension of the rod 10, the servo orifice area 16 increases (i.e., the aperture dilates), thus reducing servo pressure until the piston 11 becomes balanced and motion of the rod 10 is terminated.

For any given steady state position, the actuator 1 does not require electrical power. Hydraulics hold the piston in place. Normal friction and the motor detent torque will hold the gear train (e.g., rotary gear drive) in place. Therefore, during operation, in the case of a loss to electrical power, the piston 11 does not respond. Increasing or decreasing the load on the rod 10 will not affect the motion because the hydraulic servo will adjust the pressure balance over very small motion to adjust for load variations. Therefore, there is no “drift” in the system, thus producing a fail fixed state.

As set forth herein, the present invention includes a linear acting actuator that utilizes a rotary cam in conjunction with a follow on servo to create a fail fixed actuation system. The majority of devices in the field typically use multiple additional control elements and usually suffer from drift, as described above, or rely on a friction application, which requires a signal to operate. The present invention lacks the drawbacks known in the field and provides a fail fixed actuator having zero drift that may continue to operate in the absence of electrical power.

A number of patent and non-patent publications may be cited herein in order to describe the state of the art to which this invention pertains. The entire disclosure of each of these publications is incorporated by reference herein.

While certain embodiments of the present invention have been described and/or exemplified above, various other embodiments will be apparent to those skilled in the art from the foregoing disclosure. The present invention is, therefore, not limited to the particular embodiments described and/or exemplified, but is capable of considerable variation and modification without departure from the scope and spirit of the appended claims.

Moreover, as used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

Furthermore, the transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinary associated with the specified material(s). The term “consisting essentially of” limits the scope of a claim to the specified elements, steps or material(s) and those that do not materially affect the basic and novel characteristic(s) of the claimed invention. All devices and methods described herein that embody the present invention can, in alternate embodiments, be more specifically defined by any of the transitional terms “comprising,” “consisting essentially of,” and “consisting of.”

What is claimed is:

1. A fail fixed actuator, comprising:
a. a rod comprising a piston and a fluid channel extending axially through the rod, the rod comprising a servo orifice at a surface of the rod that is in fluid communication with the fluid channel;
b. a cam that covers a portion of the rod in close fitting relation, the cam comprising a groove, wherein the servo orifice and a portion of the groove combine to form an aperture and movement of at least one of the cam and rod varies the size of the aperture; and
c. a piston chamber configured to contain the piston, the piston chamber comprising a high pressure chamber and a servo pressure chamber, wherein the servo pressure chamber is in fluid communication with the fluid channel.

2. The actuator of claim 1, comprising a high pressure fluid source connected to at least one of the high pressure chamber and servo pressure chamber.

3. The actuator of claim 2, comprising a flow restrictor interposed between the servo pressure chamber and the high pressure source.

4. The actuator of claim 3, wherein the flow restrictor comprises a pinhole orifice.

5. The actuator of claim 1, comprising a low pressure chamber configured to fluidly communicate with the servo orifice.

6. The actuator of claim 5, comprising a low pressure fluid source connected to the low pressure chamber.

7. The actuator of claim 5, wherein the low pressure chamber encloses the cam.

8. The actuator of claim 1, comprising a motor connected to the cam and configured to rotate the cam about the rod.

9. The actuator of claim 8, wherein the motor is connected to the cam through a gear train.

10. The actuator of claim 8, wherein the motor is a stepper motor.

11. The actuator of claim 1, wherein the groove comprises a substantially triangular shape.

12. The actuator of claim 11, wherein the substantially triangular shape comprises right, obtuse, or equilateral triangular shape.

13. The actuator of claim 11, wherein the groove comprises a cut out from the cam.

14. The actuator of claim 1, wherein the cam comprises a cam cylinder.

15. The actuator of claim 1, wherein the cam is configured to extend the rod by dilating the aperture of the servo orifice.

16. The actuator of claim 1, wherein the cam is configured to retract the rod by contracting the aperture of the servo orifice.
